(19) United States
(12) Patent Application Publication
(10) Pub. No.: US 2025/0266633 A1
(43) Pub. Date: Aug. 21, 2025

(54) ELECTRICAL CONNECTION PIN ASSEMBLY

(71) Applicant: Siemens Energy Limited, Newcastle Upon Tyne (GB)

(72) Inventor: Thomas Cox, Ulverston (GB)

(21) Appl. No.: 19/046,930

(22) Filed: Feb. 6, 2025

(30) Foreign Application Priority Data
Feb. 21, 2024 (GB) 2402473.9

(51) Int. Cl. H01R 13/03; H01R 4/18; H01R 43/16

(52) U.S. Cl. CPC H01R 13/03; H01R 4/183; H01R 43/16

(57) ABSTRACT

An electrical connection pin assembly for use in a subsea environment includes a pin tip having a main body and one of a sheath and a core that extends along a centerline. The pin tip is formed from a corrosive resistant material and a main conductor includes the other of the sheath and the core. The core is disposed within the sheath, and the main conductor is formed from an electrically conductive material that is different from the corrosive resistant material. A crimped joint is formed between the core and the sheath to electrically and mechanically attach the main conductor to the pin tip, and an insulating layer is formed to sealably cover a portion of the core and a portion of the sheath.

### FIELD OF INVENTION

The present invention relates to an electrical connection pin assembly and a method of manufacturing the electrical connection pin assembly. The electrical connection pin assembly is suitable for use in subsea environments and other corrosive environments.

### BACKGROUND

Conventional electrical connection pins are formed from a conductive core and an insulative sheathing. Due to the corrosive environment that connectors are deployed in such as subsea, corrosion resistant materials are required for both male and female connector parts. However, for effective electrical connection, a low resistivity material is desired for conductors. Conductor materials do not typically possess both corrosion resistance and low resistivity. Therefore, conventional solutions are to sheath, coat, plate or otherwise attach a corrosion resistant material to a conductive core. Where the insulation is provided by overmolding the conductor core with a polymer, the conductor core must be resilient to the molding temperatures and conditions.

One known solution is for copper conductors to be plated in various less reactive materials (e.g., gold or silver). Plating and coating processes do not last indefinitely, even thick coatings wear away or become porous. At that point, the copper core is exposed and will corrode.

Another known solution is for conductors to be made from solid corrosion resistant materials (e.g., Super Duplex Stainless Steel). Fully corrosion resistant conductors are typically poor conductors and thus decrease the current carrying capacity of the conductor.

Another known solution is for corrosion resistant tips to be threaded into the copper conductor core. Threaded tips require significant machining and are less viable as the size of the conductor decreases. The sharp edges of the thread can be detrimental to electrical profiles (i.e., electrical breakdown can occur due to the points of the thread).

Another known solution is for corrosion resistant tips to be welded onto the copper conductor core. However, welding operations are typically expensive, highly skilled and require significant certification and verification testing.

Another known solution is for corrosion resistant tips to be glued onto the copper conductor core. However, adhesives typically cannot withstand the molding environment and would be compromised by the high temperatures. This would require the tip to be glued in place after the molding operation which exposes the glue and potentially the joint between the tip and the core. Such exposure could lead to crevice corrosion occurring.

Thus, there is a desire to provide an improved electrical connection pin assembly that has low electrical resistivity and high corrosion resistance for use in subsea environments.

### SUMMARY

Thus, one object of the present invention is to provide a more corrosion resistant electrical connection pin assembly. Another object of the present invention is to provide a less resistive electrical connection pin assembly. Another object of the present invention is to provide a more robust electrical connection pin assembly. Another object of the present invention is to provide a simpler method of manufacturing an electrical connection pin assembly.

In one aspect, an electrical connection pin assembly for use in a subsea environment includes a pin tip having a main body and one of a sheath and a core that extends along a centerline. The pin tip is formed from a corrosive resistant material and a main conductor includes the other of the sheath and the core. The core is disposed within the sheath, and the main conductor is formed from an electrically conductive material that is different from the corrosive resistant material. A crimped joint is formed between the core and the sheath to electrically and mechanically attach the main conductor to the pin tip, and an insulating layer is formed to sealably cover a portion of the core and a portion of the sheath.

In another aspect, the electrical connection pin assembly includes a corrosive resistant material that includes one of gold, silver, nickel, molybdenum, titanium, and chrome in elemental or alloy form.

In another aspect, the electrical connection pin assembly includes an electrically conductive material formed from one of copper, aluminum, a copper alloy, and an aluminum alloy.

In another aspect, the electrical connection pin assembly includes an insulating layer that covers the sheath.

In another aspect, the electrical connection pin assembly includes a sheath that defines a hollow portion sized to receive the core.

In another aspect, the electrical connection pin assembly includes a pin tip that includes the sheath, and a main conductor that includes the core.

In another aspect, the electrical connection pin assembly includes a pin tip that includes the core, and a main conductor that includes the sheath.

In another aspect, the electrical connection pin assembly includes an electrically conductive material that has an electrical resistivity that is lower than the electrical resistivity of the corrosion resistant material.

In another aspect, the electrical connection pin assembly includes a corrosion resistant material that has a pitting resistance equivalent number greater than 32.

In another aspect, the electrical connection pin assembly includes a corrosion resistant material that has a pitting resistance equivalent number greater than 40.

In another aspect, the electrical connection pin assembly includes a pin tip that includes one of the group including Inconel®, Monel®, Super Duplex®, or a nickel-based alloy.

In another aspect, the electrical connection pin assembly includes a pin tip formed from material that has an electrical resistance greater than the material that forms the main conductor.

In another aspect, the electrical connection pin assembly includes a main conductor that is formed from material that has an electrical resistance less than 5E-08 Ohm·m.

Other technical features may be readily apparent to one skilled in the art from the following figures, descriptions, and claims.

In another aspect, a method of forming an electrical connection pin assembly for use in a subsea environment includes forming a pin tip from a corrosive resistant material, the pin tip including a main body and one of a sheath and a core that extends along a centerline. The method also includes forming a main conductor from an electrically conductive material, the main conductor including the other of the sheath and the core, positioning the sheath to surround a portion of the core, compressing the sheath against the core to form a crimped joint, and overmolding an insulating layer onto a portion of the core and a portion of the sheath to sealably enclose an interface between the sheath and the core and inhibit contact between water in the subsea environment and the interface.

The method of manufacturing the electrical connection pin assembly may include a pin tip that includes the sheath and a main conductor that includes the core.

The method of manufacturing the electrical connection pin assembly may include an electrically conductive material that includes one of copper, aluminum, a copper alloy, and aluminum alloy.

The method of manufacturing the electrical connection pin assembly may include a corrosive resistant material that includes one of gold, silver, nickel, titanium, and chrome in elemental or alloy form.

The method of manufacturing the electrical connection pin assembly may include machining the insulating layer to remove a portion of the insulating layer to achieve a desired dimension of the insulating layer.

The method of manufacturing the electrical connection pin assembly may include the step of machining each of the pin tip and the insulating layer to a desired dimension.

The method of manufacturing the electrical connection pin assembly may further include selecting an electrically conductive material that has an electrical resistivity that is lower than the electrical resistivity of the corrosion resistant material.

Other technical features may be readily apparent to one skilled in the art from the following figures, descriptions, and claims.

### BRIEF DESCRIPTION OF THE DRAWINGS

The above-mentioned attributes and other features and advantages of the present invention and the manner of attaining them will become more apparent and the present technique itself will be better understood by reference to the following description of embodiments of the present technique taken in conjunction with the accompanying drawings, wherein:

FIG. 1 is a perspective view of a portion of an electrical connection pin assembly.

FIG. 2 is a longitudinal section through the portion of the electrical connection pin assembly of FIG. 1.

FIG. 3 is a longitudinal section through the portion of the electrical connection pin assembly of FIG. 1 with the addition of an insulating layer.

FIG. 4 is a perspective view of another arrangement of a portion of an electrical connection pin assembly.

FIG. 5 is a longitudinal section through the portion of the electrical connection pin assembly of FIG. 4.

FIG. 6 is a longitudinal section through the portion of the electrical connection pin assembly of FIG. 4 with the addition of an insulating layer.

FIG. 7 is a perspective view on the electrical connection pin assembly in a finished state.

### DETAILED DESCRIPTION

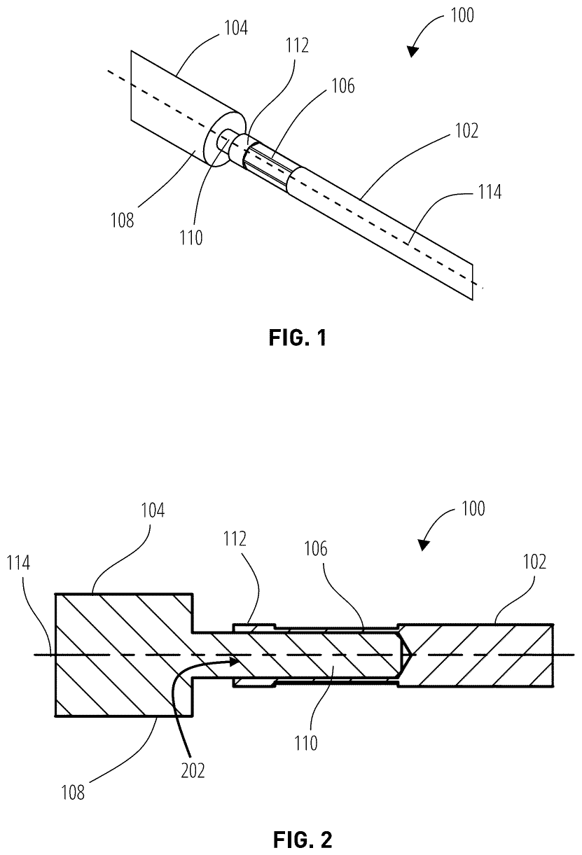

FIG. 1 illustrates a partial pin assembly and in particular a partial electrical connection pin assembly 100 that is well-suited for use in a subsea environment. “Subsea environment” refers to the region beneath the surface of the sea, ocean, or any body of water. This encompasses the seabed, the water column, and any structures, systems, or equipment that are installed or operated in this subsea area. The subsea environment is often characterized by high pressures (i.e., greater than 10 Bar), low temperatures (less than 10 degrees C.), and corrosive conditions that present unique challenges for the design and operation of underwater technologies and infrastructure.

The portion of the electrical connection pin assembly 100 illustrated in FIG. 1 includes a main conductor 102 and a pin tip 104. The pin tip 104 includes a main body 108 and a core 110. The core 110 extends from the main body 108 along a centerline 114 or longitudinal axis. The main conductor 102 operates as the main conductor for the cable, wire, or connection and generally includes a core conductor and a layer of insulation.

The main conductor 102 includes a sheath 112 that extends over the core 110. A crimped joint 106 is formed between the sheath 112 and the core 110 to form a physical and electrical connection between the main conductor 102 and the pin tip 104.

Because the main conductor 102 can be quite long when compared to the pin tip 104 it is desirable that a good electrical conductor such as copper, copper alloys, aluminum, or aluminum alloys be used. In preferred constructions, the material used has an electrical resistance that is less than 5E-08 Ohm·m. However, as one of ordinary skill will understand, the subsea environment can be very aggressive, and these materials are susceptible to corrosion in many subsea environments.

The pin tip 104 is formed from an electrically conductive material that has improved corrosion resistance. The main conductor 102 is formed from a highly electrically conductive material, but without needing to be corrosion resistant. The main conductor 102 may have a significantly lower electrical resistivity than the pin tip 104. For example, a copper main conductor 102 might have a resistivity of 1.68e-8Ω·m. Another suitable material for the main conductor 102 is aluminum or an alloy of aluminum and which may have a resistivity of about 2.65e-8Ω·m depending on the particular alloy.

The pin tip 104 may be formed from a corrosion resistant material like Inconel® 625 which has an electrical resistivity of 1.29e-6Ω·m or a Monel® 400 having a resistivity of 5.47e-7Ω·m. Other materials suitable for the pin tip 104 include but are not limited to Molybdenum R03600 having a resistivity of 5.34E-08Ω·m and Super Duplex® S32760 having a resistivity of 8E-07Ω·m.

As mentioned, the pin tip 104 is formed from an electrically conductive material with good and preferably excellent corrosion resistance. The definition of “corrosion resistant” used herein corresponds to the definition provided in the International Standard Organization (ISO) 15156 which specifies materials as being seawater resistant if the pitting resistance equivalent number (PREN) of the material is greater than or equal to 32 (good corrosion resistance) and preferably greater than or equal to 40 (excellent corrosion resistance). Usually, materials having a PREN above 40 comprise a metallic alloy such as any Inconel® or any Monel®. Two examples are Inconel® 625 and Monel® 400 which have excellent corrosion resistance and essentially do not corrode in seawater. Materials having a PREN between 32 and 40, such as Molybdenum R03600 (essentially pure Molybdenum) and Super Duplex® S32760, have good corrosion protection and may be used for the pin tip 104. Super Duplex® S32760 is a stainless steel and other stainless steels may be used that have a PREN greater than or equal to 32. Other examples of materials having good or excellent corrosion resistance are nickel-based alloys such as Incoloy®, Hastalloy® or NiBron®.

It should be appreciated that the materials listed above are a few of many examples of materials that are listed in ISO 15156 or would otherwise have a PREN greater than or equal to 32 and preferably greater than or equal to 40. Furthermore, the term “corrosion resistant” may also be defined as a material in accordance with ISO 10423 or ISO 13688. Nonetheless, materials, such as copper or copper alloys, that are not deemed corrosion resistant and have a PREN below 32 are not used for the pin tip 104. PREN numbers are determined for alloys that contain certain specific materials (the PREN is calculated based on the percentage of those materials in the alloy). As such, materials such as gold, silver, molybdenum or titanium do not have a PREN number, despite being corrosion resistant. Thus, while these materials do not have a PREN number, they are well-suited for use as corrosion resistant materials.

It should be noted that the terms “greater than” and “less than” should be interpreted to include the endpoints. As such, “greater than” should be read as “greater than or equal to” and “less than” should be read as “less than or equal to”.

FIG. 2 illustrates the portion of the electrical connection pin assembly 100 illustrated in FIG. 1 in a cross-sectional view to better illustrate the relative positions of the main conductor 102, the pin tip 104, and the crimped joint 106.

As can be seen, the main conductor 102 and the pin tip 104 each extend along the centerline 114 (sometimes referred to as a longitudinal axis). The sheath 112 defines a hollow space 202 that is sized to receive a portion of the core 110.

The crimped joint 106 is formed by compressing or swaging a portion of the sheath 112 such that it compresses against and squeezes the core 110 that is disposed within the hollow space 202.

The crimped joint 106 can be formed using simple tools with little or no training and skill. In addition, the crimped joint 106 provides a stable mechanical connection and provides for good electrical connectivity between the core 110 and the sheath 112. Additionally, no special materials such as weld fillers, brazes, adhesives and the like are required to form the connection. Thus, the connection between the main conductor 102 and the pin tip 104 can be made inexpensively and quickly with a very low failure rate, thereby reducing the cost and the lead time of the electrical connection pin assembly 100.

It should be noted that while FIG. 1 and FIG. 2 illustrate a cylindrical core 110 that has a solid circular cross section and a corresponding cylindrical hollow space 202, other shapes and arrangements are possible. In addition, the sheath 112 is illustrates as being a continuous annular cylinder (or tubular) in cross section, other arrangements may include a discontinuous sheath 112. For example, the sheath 112 could include two or more fingers, or an annular array of fingers that are separated from one another but that each define a portion of the annular cylinder defined by the illustrated sheath 112.

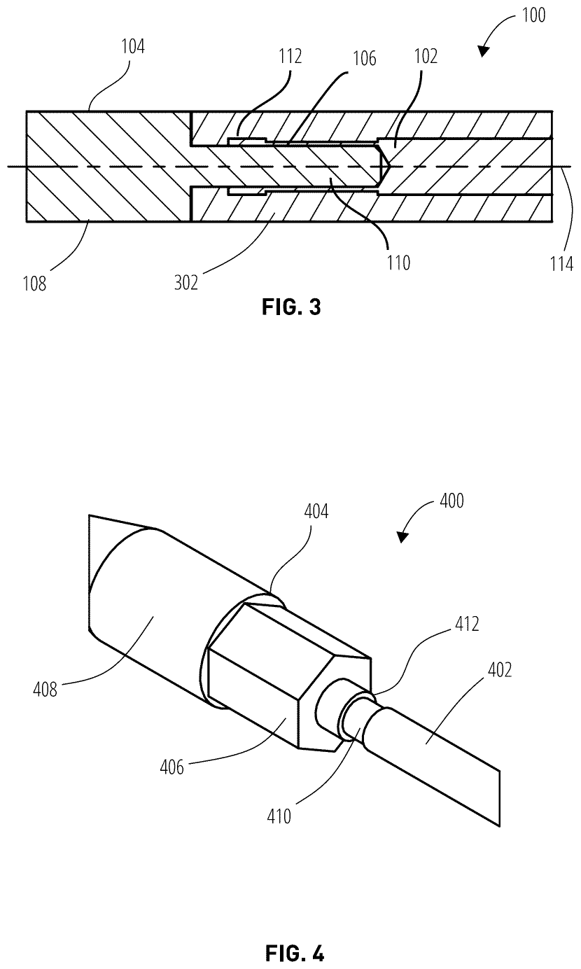

FIG. 3 illustrates a completed electrical connection pin assembly 100 in cross-section to illustrate the relationship between the components. FIG. 3 includes the arrangement illustrated in FIG. 2 with the addition of an insulating layer 302. The insulating layer 302 is placed, molded, or formed in position to cover the entire core 110 and a portion of the main conductor 102. In preferred arrangements, the insulating layer 302 is molded into place to complete the assembly and to form a seal to inhibit water, or any other atmospheric element from contacting the crimped joint 106 or the exposed portion of the main conductor 102. While the arrangement of FIG. 3 allows for the formation of the insulating layer 302 to size such that machining may not be required, some constructions may form the insulating layer 302 oversized and then machine it to the desired size.

The insulating layer 302 is formed from an electrically insulating material and one that is corrosion resistant in the subsea environment. Possible materials suitable for use as the insulating layer 302 include PEEK (Poly Ether Ether Ketone) or other known electrically insulating and protective materials. The insulating layer 302 covers a portion of the main conductor 102, the crimped joint 106, and any exposed portion of the core 110 and abuts the main body 108 of the pin tip 104. The insulating layer 302 inhibits corrosive fluid, such as seawater, from contacting the main conductor 102, the crimped joint 106, and the exposed core 110.

While not illustrated, to complete the assembly of the electrical connection pin assembly 100, the insulating layer 302 and a portion of the pin tip 104 may be machined to a final desired shape or diameter. The machining assures that the insulating layer 302 sufficiently covers the desired features and components while also meeting its desired fit and function. Machining the pin tip 104 and in particular the main body 108 of the pin tip 104 assures a smooth, electrically conductive, but corrosion resistant surface is exposed for making the electrical connection.

In some constructions, irregular-shaped surfaces or lock profiles, or roughened surfaces are provided to one or more of the core 110, the sheath 112, or a portion of the main conductor 102 to enhance the engagement between these surfaces and the insulating layer 302.

FIG. 4 illustrates a portion of an alternative arrangement of the electrical connection pin assembly 100 of FIG. 1 through FIG. 3. The electrical connection pin assembly 400 includes a main conductor 402 and a pin tip 404. However, in contrast to the electrical connection pin assembly 100, the main conductor 402 of the electrical connection pin assembly 400 extends into the pin tip 404 rather than vice versa.

The pin tip 404 includes a main body 408 and a sheath 412 that, in the illustrated construction has a hexagonal cross-section that is the result of the crimping operation that forms a crimped joint 406. Prior to the formation of the crimped joint 406, the main body 408 is cylindrical. Of course, other cross-sections for the sheath 412 including cylindrical or other polygonal shapes are possible, both before and after crimping.

The crimped joint 406 is formed between the pin tip 404 and the main conductor 402. Specifically, the sheath 412 is compressed into the main conductor 402 to complete the crimped joint 406.

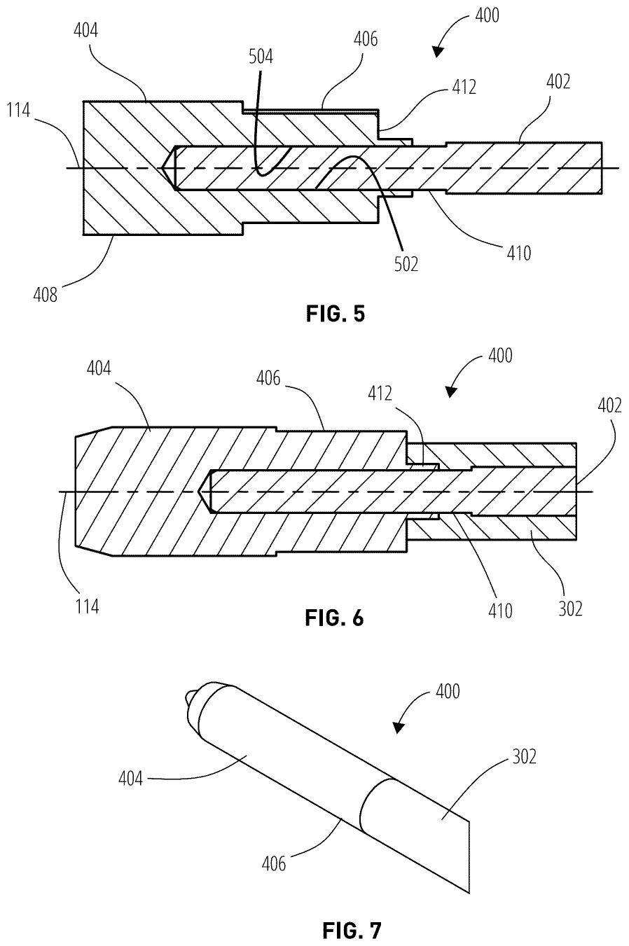

FIG. 5 is a cross-sectional view of the partial electrical connection pin assembly 400 as illustrated in FIG. 4. As illustrated, the main conductor 402 extends along the centerline 114 and includes a core 410. The core 410 (exposed portion of the main conductor 402) is generally a solid cylinder having a circular cross-section with other shapes or arrangements being possible.

The pin tip 404 extends along the centerline 114 with the sheath 412 defining a recess or hollow space 502 therein. The core 410 of the main conductor 402 is received within the hollow space 502 defined by the sheath 412 and the sheath 412 is compressed to form the crimped joint 406 to mechanically and electrically connect the main conductor 402 and the pin tip 404 at an interface 504.

FIG. 6 illustrates the completed electrical connection pin assembly 400 prior to any machining. The electrical connection pin assembly 400 includes the components illustrated in FIG. 5 and further including an insulating layer 302 that is applied in a position to cover the exposed portion of the core 410, a portion of the sheath 412, and a portion of the main conductor 402. The positioning of the insulating layer 302 seals an opening to the interface 504 and thereby inhibits entry of the outside environment into contact with the interface 504.

The insulating layer 302 may be formed of an electrical insulating material such as PEEK (Poly Ether Ether Ketone) or other known electrically insulating and protective materials and may be applied via a molding process. The insulating layer 302 covers a portion of the main conductor 402 and abuts the sheath 412 near the crimped joint 406. The insulating layer 302 inhibits corrosive fluid, such as sea water, from contacting the main conductor 402 or entering the crimped joint 406.

In many constructions, the electrical connection pin assembly 400 is machined after the molding or application of the insulating layer 302 to assure that the insulating layer 302 meets a desired dimension. In addition, during this machining process, the pin tip 404 may also be machined to assure that it has the proper size for its intended use as well as a clean exposed surface to provide the suitable electrical conductivity while remaining resistant to corrosion.

The ability to machine the pin tip 104, 404 as well as the insulating layer 302 is a significant improvement found in the constructions discussed herein. In prior designs, a plated copper core was used and the machinist had to be very skilled to avoid damaging the plating while machining the insulating layer 302. With a corrosion resistant pin tip 104, 404, as described herein this additional care and skill is not needed thereby making the machining easier and less likely to cause damage that would require reworking or scrapping. The illustrated arrangements also allow for a single diameter on both the pin tip 104, 404 and the insulating layer 302 which is beneficial for seals. In prior designs, the machinist had to be very skilled to avoid forming a small step in the diameter which is bad for seals.

FIG. 7 illustrates one possible arrangement of the electrical connection pin assembly 400 following machining and in a finished state. Depending on the desired diameter of the electrical connection pin assembly 400, the main body 408 and/or the crimped joint 406 and/or the insulating layer 302 may be machined to a uniform diameter as shown. In addition, crimping or swaging can leave sharp edges that are undesirable. The machining step removes these sharp edges in the arrangement of the electrical connection pin assembly 400 of FIG. 4 through FIG. 6. In the electrical connection pin assembly 100 of FIG. 1 through FIG. 3, the sharp edges are still present but are buried within the insulating layer 302.

The arrangement of the electrical connection pin assembly 400 of FIG. 4 through FIG. 6 is therefore preferable electrically to the arrangement of the electrical connection pin assembly 100 of FIG. 1 through FIG. 3, at least where high voltages are present (the sharp edges can cause electrical breakdown or partial discharge-both are electrical failure modes). The formation of the crimped joint 106 would likely use a circular crimp die in an effort to avoid or minimize these sharp edges. However, the formation of the crimped joint 406 could use any desired crimping tool or die as any sharp edges are removed during machining.

As the crimping or swaging operation or the crimped joint 106, 406 itself is not affected by the molding environment or temperatures, the crimped joints 106, 406 can be made prior to molding the insulating layer 302. The insulating layer 302 can then cover or seal access to the crimped joint 106, 406 thereby forming a corrosion resistant barrier. The crimping/swaging operation does not require highly skilled operators as the tools used are simple, common, and inexpensive. The crimping or swaging operation results in a repeatable and effective electrical joint. It does not require significant verification and does not leave sharp irregular edges.

To assemble the electrical connection pin assembly 100 the user first forms or establishes the hollow space 202 in the end of the main conductor 102, thereby defining the sheath 112. The pin tip 104 is positioned along the same centerline 114 as the main conductor 102 and the core 110 of the pin tip 104 is inserted into the hollow space 202 defined by the sheath 112.

Using common tools and techniques, the user compresses a portion of the sheath 112 to form the crimped joint 106 between the main conductor 102 and the pin tip 104. The crimped joint 106 defines a mechanical connection between the main conductor 102 and the pin tip 104 and also provides a good electrical connection.

The insulating layer 302 is then formed or molded to cover at least a portion of the sheath 112 and the exposed portion of the core 110. The insulating layer 302 and in some cases a portion of the pin tip 104 are then machined to a final size and shape to meet the particular requirements of the application.

The assembly of the electrical connection pin assembly 400 is similar to the assembly of the electrical connection pin assembly 100. The main conductor 402 is positioned such that it extends along the centerline 114 to place the core 410 in a desired position. The pin tip 404 is formed to include a sheath 412 that defines a hollow space 502 within the pin tip 404 rather than in the main conductor 102 as shown in FIG. 1 and FIG. 2.

The core 410 is inserted into the hollow space 502 and the sheath 412 is compressed to define the crimped joint 406. The crimped joint 406, once formed mechanically connects the main conductor 402 and the pin tip 404. In addition, the crimped joint 406 provides a good electrical connection between the main conductor 402 and the pin tip 404.

The insulating layer 302 is formed to cover the exposed portion of the core 410, a portion of the sheath 412, and a portion of the main conductor 402. The insulating layer 302 and in some instances the pin tip 404 are machined until the electrical connection pin assembly 400 meets the desired dimensions and shape for the particular application.

As should be clear, the two constructions illustrated herein each include a core and a sheath that defines a hollow portion. However, the positions of these components are reversed in the two constructions. In the arrangement of FIG. 1 through FIG. 3 the main conductor 102 includes the sheath 112 that defines the hollow space 202. In contrast, the construction of FIG. 4 through FIG. 6 includes a pin tip 404 that includes the sheath 412 that defines the hollow space 502. In addition, in the first construction of the electrical connection pin assembly 100, the core 110 is formed as part of the pin tip 104. However, in the second construction of the electrical connection pin assembly 400, the core 410 is part of the main conductor 402.

All the features disclosed in this specification (including any accompanying claims, abstract and drawings), and/or all the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An electrical connection pin assembly for use in a subsea environment, the pin assembly comprising:
a pin tip having a main body and one of a sheath and a core that extends along a centerline, the pin tip formed from a corrosive resistant material;
a main conductor including the other of the sheath and the core, the core disposed within the sheath, the main conductor formed from an electrically conductive material that is different from the corrosive resistant material;
a crimped joint formed between the core and the sheath to electrically and mechanically attach the main conductor to the pin tip; and
an insulating layer formed to sealably cover a portion of the core and a portion of the sheath.

2. An electrical connection pin assembly as claimed in claim 1, wherein the corrosive resistant material includes one of gold, silver, nickel, molybdenum, titanium, and chrome in elemental or alloy form.

3. An electrical connection pin assembly as claimed in claim 2, wherein the electrically conductive material is formed from one of copper, aluminum, a copper alloy, and an aluminum alloy.

4. An electrical connection pin assembly as claimed in claim 1 wherein the insulating layer covers the sheath.

5. An electrical connection pin assembly as claimed in claim 1 wherein the sheath defines a hollow portion sized to receive the core.

6. An electrical connection pin assembly as claimed in claim 1 wherein the pin tip includes the sheath, and the main conductor includes the core.

7. An electrical connection pin assembly as claimed in claim 1 wherein the pin tip includes the core, and the main conductor includes the sheath.

8. An electrical connection pin assembly as claimed in claim 1, wherein the electrically conductive material has an electrical resistivity that is lower than the electrical resistivity of the corrosion resistant material.

9. An electrical connection pin assembly as claimed in claim 1 wherein the corrosion resistant material has a pitting resistance equivalent number greater than 32.

10. An electrical connection pin assembly as claimed in claim 1 wherein the corrosion resistant material has a pitting resistance equivalent number greater than 40.

11. An electrical connection pin assembly as claimed in claim 1 wherein the pin tip includes one of the group including Inconel®, Monel®, Super Duplex®, or a nickel-based alloy.

12. An electrical connection pin assembly as claimed in claim 1 wherein the pin tip is formed from material that has an electrical resistance greater than the material that forms the main conductor.

13. An electrical connection pin assembly as claimed in claim 1 wherein the main conductor is formed from material that has an electrical resistance less than 5E-08 Ohm·m.

14. A method of forming an electrical connection pin assembly for use in a subsea environment, the method comprising:
forming a pin tip from a corrosive resistant material, the pin tip including a main body and one of a sheath and a core that extends along a centerline;
forming a main conductor from an electrically conductive material, the main conductor including the other of the sheath and the core;
positioning the sheath to surround a portion of the core;
compressing the sheath against the core to form a crimped joint; and
overmolding an insulating layer onto a portion of the core and a portion of the sheath to sealably enclose an interface between the sheath and the core and inhibit contact between water in the subsea environment and the interface.

15. A method of manufacturing an electrical connection pin assembly as claimed in claim 14, wherein the pin tip includes the sheath and the main conductor includes the core.

16. A method of manufacturing an electrical connection pin assembly as claimed in claim 14, wherein the electrically conductive material includes one of copper, aluminum, a copper alloy, and aluminum alloy.

17. A method of manufacturing an electrical connection pin assembly as claimed in claim 14, wherein the corrosive resistant material includes one of gold, silver, nickel, titanium, and chrome in elemental or alloy form.

18. A method of manufacturing an electrical connection pin assembly as claimed in claim 14, further comprising machining the insulating layer to remove a portion of the insulating layer to achieve a desired dimension of the insulating layer.

19. A method of manufacturing an electrical connection pin assembly as claimed in claim 14 wherein the method further comprises the step of machining each of the pin tip and the insulating layer to a desired dimension.

20. A method of manufacturing an electrical connection pin assembly as claimed in claim 14, further comprising selecting an electrically conductive material that has an electrical resistivity that is lower than the electrical resistivity of the corrosion resistant material.
